(19) United States
(12) Patent Application Publication
(10) Pub. No.: US 2025/0137886 A1
(43) Pub. Date: May 1, 2025

(54) MULTI-AXIS CENTRIFUGE AND SYSTEMS AND METHODS OF TESTING A VEHICLE FIXTURE

(71) Applicant: Honda Motor Co., Ltd., TOKYO (JP)

(72) Inventors: Nathanael Myers, Dublin, OH (US); Sundaram Raghuraman, Carmel, IN (US); Dwayne William Malone, Plain City, OH (US); Nathaniel J. Buchheit, Marysville, OH (US); Charles S. Haase, Delaware, OH (US)

(21) Appl. No.: 18/618,733

(22) Filed: Mar. 27, 2024

Related U.S. Application Data
(60) Provisional application No. 63/594,605, filed on Oct. 31, 2023.

(51) Int. Cl. G01M 99/00; B04B 9/02; B04B 13/00

(52) U.S. Cl. CPC G01M 99/004; B04B 13/00; B04B 9/02

(57) ABSTRACT

A testing assembly for use in testing a vehicle fixture is provided. The testing assembly includes a multi-axis centrifuge, a fixturing plate, a braking assembly, and a controller. The multi-axis centrifuge includes a central arm that is configured to rotate circumferentially along a rail guide. The fixturing plate is secured to a first end of the central arm. The fixturing plate includes a plurality of openings sized to receive a fastener assembly therethrough for securing the vehicle fixture in a desired position and orientation to the fixturing plate. The braking assembly includes at least one electric actuator coupled to the central arm for selectively stopping rotation of the central arm. The controller provides dynamic control of the multi-axis centrifuge using data gathered from at least one complete build-up test of a vehicle. The controller receives additional data from the testing assembly during testing of a vehicle fixture.

### CROSS-REFERENCE TO RELATED APPLICATIONS

This application claims the benefit of priority to U.S. Provisional Patent Application Ser. No. 63/594,605, filed Oct. 31, 2023, and entitled “MULTI-AXIS CENTRIFUGE AND SYSTEMS AND METHODS OF TESTING A VEHICLE FIXTURE”, the contents and disclosures of which are hereby incorporated in their entirety.

### FIELD OF THE INVENTION

The present disclosure relates to centrifuge systems and vehicle fixtures and, more particularly, to systems and methods for testing a vehicle small item storage holder or a vehicle fixture, such as a vehicle beverage carrier or a vehicle drink holder.

### BACKGROUND

Cup holders were first included in vehicles assembled and/or manufactured in the early 1980s. Although beverage drink holders are often used for storage of many items other than merely cups or drinking vessels, the primary function of such holders is to hold and retain beverage containers of different sizes in a convenient location for a vehicle occupant. Such vehicle fixtures provide a convenience and safety to people who are within the car and newer designs are configured to maintain the beverage container in a level condition as the vehicle moves, so much so that consumers may consider the design, location, and number of cup holders in a vehicle to be an important attribute in influencing their vehicle purchase.

Accordingly, vehicle beverage holders are a design consideration for vehicle manufacturers. More specifically, such design considerations not only include the location of the beverage holders, but also ensuring that the beverage holder retains the beverage container in the cup holder assemblies during vehicle movement. For example, the beverage container should be sized to enable beverage containers to be easily inserted and removed from the cup holder, and although tipping of the beverage container within the beverage cup holder assembly is allowed, the beverage container should remain secured within the cup holder assembly. To ensure that the beverage cup holder assembly is designed to enable a cup inserted therein to withstand the forces that it may be subjected to as the vehicle moves, at least some known cup holder assemblies are subjected to testing during the design phase of the vehicle manufacturer. More specifically, such testing is often performed to evaluate the retention of a beverage container in a vehicle cup holder assembly during vehicle acceleration, vehicle braking, vehicle turning, and/or during movement of a vehicle over rough or un-even terrain.

At least some known beverage cup holder testing involves coupling a plurality of sensors about the vehicle cup holders, inserting a beverage container in such cup holders, and monitoring the forces induced to the beverage cup holders and beverage containers as the associated vehicle transgresses through a test course designed to subject the vehicle to a plurality of different dynamic forces. Such testing, known as a complete build-up (CBU) test generally provides only limited results, may be time-consuming, and may be weather dependent, i.e., such testing may be limited depending on seasonal availability. Moreover, such testing can be costly, and because such testing may provide only limited collection capabilities, the test results may be difficult to replicate.

Other known testing may be performed in ergonomic labs that use equipment to simulate the vehicle operating conditions. Such equipment commonly includes a cup holder assembly that is coupled to a rotating platform driven by a variable speed motor and that includes a gear box designed to control the rotation of the platform at a desired speed, and/or that is used to selectively stop the rotation of the platform to simulate braking of the vehicle. Rotation of the testing platform attempts to simulate the forces that the cup holder and a beverage contained therein may be exposed to during movement, including acceleration, and/or turning. However, such testing methodology may provide only limited data analysis functionality, may require time-consuming data processing, and may not be able to replicate all of the CBU testing conditions. Moreover, such testing equipment may not produce reliable, repeatable results. Other known testing may be performed to validate the design of a small item storage fixture that may be included within the vehicle. For example, such storage fixtures may include storage pockets, coin trays, phone holders, and/or wireless charging units.

Accordingly, it is desirable to have testing equipment and systems and methods for use with vehicle fixtures, wherein the testing equipment and systems can simulate all of the CBU testing conditions, can enhance data collection methodologies and can ensure repeatable data is provided.

### BRIEF SUMMARY

In one aspect, a multi-axis centrifuge including a rotating arm, a motor, a fixturing plate, at least one braking assembly, and a controller is provided. The rotating arm has a main axis and includes a first end, and an opposite second end. The motor drives movement of the arm, and the fixturing plate is coupled to an outermost edge of the arm first end such that the fixturing plate is rotatable about the arm main axis. The braking assembly is coupled to the arm second end, and the controller dynamically drives operation of the multi-axis centrifuge.

In another aspect, a testing assembly for use in testing a vehicle fixture is provided. The testing assembly includes a multi-axis centrifuge, a fixturing plate, a braking assembly, and a controller. The centrifuge includes a central arm that is coupled to a drive motor configured to rotate the central arm circumferentially along a rail guide. The fixturing plate is secured to a first end of the central arm, and includes a plurality of openings sized to receive a fastener assembly therethrough for securing the vehicle fixture in a desired position and orientation to the fixturing plate. The braking assembly includes at least one electric actuator coupled to the central arm for selectively stopping rotation of the central arm. The controller provides dynamic control of the multi-axis centrifuge using data gathered from at least one test vehicle. The controller receives additional data from the testing assembly during testing of a vehicle fixture.

In yet a further aspect, a method of testing a vehicle fixture is provided. The method includes coupling a vehicle fixture to a fixturing plate coupled within a multi-axis centrifuge using a coupling system that facilitates positioning the vehicle fixture in any orientation and position relative to the centrifuge, wherein the fixturing plate is coupled to a first end of a central arm of the centrifuge. The method also includes inputting data gathered from testing of at least one vehicle, wherein the data is a measure of dynamic forces induced to the at least one vehicle during testing, and dynamically controlling operation of the centrifuge using a controller. Furthermore, the method includes gathering, by the controller, data measured during testing of the vehicle fixture while coupled to the centrifuge, and determining the effectiveness of the vehicle fixture based on the data gathered during operation of the centrifuge.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an exemplary embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the Figures arrangements which are presently discussed, it being understood, however, that the present embodiments are not limited to the precise arrangements and are instrumentalities shown, wherein:

FIG. 1 illustrates a perspective view of an exemplary vehicle fixture testing assembly.

FIG. 2 is a top plan view of the testing assembly shown in FIG. 1.

FIG. 3 is an enlarged view of a portion of the testing assembly shown in FIG. 1 and taken along area 3-3 shown in FIG. 2.

FIG. 4 is side perspective view of the testing assembly shown in FIG. 1 and including a portion of deployable safety shields installed.

FIG. 5 is a side perspective view of the testing assembly shown in FIG. 3 and including all of the deployable safety shields installed.

FIG. 6 is a front perspective view of the testing assembly shown in FIG. 1.

FIG. 7 is a fixturing plate used with the testing assembly shown in FIG. 1.

FIG. 8 is a plan view of the testing assembly shown in FIG. 1 and including exemplary forces superimposed on the testing assembly.

FIG. 9 is an enlarged side view of an exemplary braking system used with the testing assembly shown in FIG. 1.

FIG. 10 is a schematic side view of the braking system shown in FIG. 9.

FIGS. 11a and 11b are each schematic side views of a portion of the testing assembly shown in FIG. 1.

FIG. 12a is a side perspective view of a portion of a plurality of motion cameras used with the testing assembly shown in FIG. 1.

FIG. 12b is a plan view of the testing assembly shown in FIG. 1 and including a plurality of motion cameras.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both, and may include a collection of data including hierarchical databases, relational databases, flat file databases, object-relational databases, object oriented databases, and/or another structured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

A computer program of one embodiment is embodied on a computer-readable medium. In an example, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in different environments without compromising any major functionality. In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

As used herein, the terms “processor” and “computer” and related terms, e.g., “processing device,” “computer device,” and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable and include any computer program storage in memory for execution by personal computers, workstations, clients, servers, and respective processing elements thereof.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of: the time of occurrence of the associated events, the time of measurement and collection of predetermined data, the time for a computer device (e.g., a processor) to process the data, and/or the time of a system response to the events and the environment. In the embodiments described herein, these activities and events may be considered to occur substantially instantaneously.

The present embodiments may relate to, inter alia, systems and methods that may be implemented to enable reliable testing and evaluation of a vehicle fixture using equipment that provides reliable and repeatable test results in a manner that is replicable. More specifically, in some of the embodiments described herein, the systems and methods may be implemented to evaluate the retention of beverage containers in vehicle cup holder assemblies using novel test equipment that enables essentially all of the complete build-up (CBU) testing conditions to be replicated in a cost-effective manner that enhances data collection methodologies. Alternatively, the systems and methods described herein may be implemented to validate the design of any vehicle small item storage holders including, but not limited to, pockets, coin trays, phone holders, and/or wireless charging units. In other embodiments, the systems and methods described herein may be used to validate the design of any storage holder designed to hold small to medium sized consumer items in a condition where harsh driving could potentially launch the consumer item into the vehicle cabin, at an occupant or driver of the vehicle, or otherwise compromise the driver's focus while on the road due to the consumer item(s) being poorly secured within the storage holder.

In the exemplary embodiment, a multi-axis centrifuge (MAC) used to perform the testing includes a rotating arm that is driven by a single motor. The arm includes a secondary fixturing plate that is secured adjacent to its outermost edge. The fixturing plate provides a standardized method for securing vehicle fixtures, including vehicle cup holders, to the MAC in a reliable and repeatable manner. Moreover, in the exemplary embodiment, the fixturing plate is engraved with a co-ordinate grid and radius lines that enable the vehicle beverage holder to be secured to the fixturing plate in a specific desired location.

In the exemplary embodiment, movement of the fixturing place is controlled by a pair of secondary motors that are coupled to the fixturing plate via a pair of rod ends. The rod ends enable the fixturing plate to rotate about a pair of localized axes (also known as a universal joint). The fixturing plate can also rotate independently about a main axis of the central arm, and at a variably selected rate of rotation, i.e., revolutions per minute (RPM). In addition, in the exemplary embodiment, a pair of detection devices, such as high-definition cameras, are slidably coupled to the MAC such that each camera always faces towards a center point of the fixturing plate as the cameras rotate about the center point of the fixturing plate. In addition, the fixturing plate also enables a user to selectively input the exact center point of the associated vehicle, thus enabling the controller to selectively adjust a rotational speed of the central arm to facilitate maintaining a substantially consistent force exerted on the vehicle fixture based on its relative position to the axis of rotation of the central arm.

In some embodiments, a pair of braking assemblies are coupled to the arm, on the outermost edge of the arm, opposite the fixturing plate. In the exemplary embodiment, the braking assemblies are each magnetic braking assemblies that each include a magnetic clamp that is driven by an electric actuator. The arm assembly of the MAC travels along a rail guide that is supported by a plurality of roller assemblies. When selectively activated, the electric actuators engage the magnetic clamp against the rail guide to rapidly stop rotation of the MAC arm. Thus, the electric actuators provide a safety feature during testing, and also provide a method of replicating braking forces and/or rapid acceleration in a vehicle. The MAC also includes retractable safety shields that are selectively positionable to enable the MAC to be circumscribed by safety shields during testing.

In the exemplary embodiment, an inertial measurement unit provides relevant force data to enable dynamic control of the MAC. More specifically, operation of the multi-axis centrifuge is based on information and data gathered from a custom programmed inertial measurement unit (IMU) that are or were positioned within at least one CBU test vehicle that had been previously driven through a controlled environment. As used herein, the CBU test vehicle may include any vehicle, including prototypes, in which data has been collected during various testing events held throughout a development cycle of the vehicles. In the exemplary embodiment, the CBU test vehicle, including the IMU, is driven through a test course that includes a plurality of different road conditions including, but not limited to, areas including left and right turns of various degrees, a range of braking from normal braking activities to sudden braking events, various acceleration spurts, U-turns, and areas including rough terrain and/or speed bumps. During the testing, the IMU detects data as the CBU is driven through the test course. In some embodiments, additional data is gathered from cameras, such as motion capture cameras. Data detected by such cameras is not transmitted to the IMU, but rather is used for internal review and verification. Data from the IMU is transmitted to a controller that controls operation of the MAC based on inputs received from the IMU. As such, testing of the vehicle fixture can be performed in a repeatable and reliable manner without the concerns and issues raised by gathering data from a CBU test vehicle in variable weather conditions, for example.

In one embodiment, the MAC controller utilizes at least two process models that may be dynamically updated by a user to determine a course of operation for the MAC. In some embodiments, the MAC controller executes an algorithm to determine the operation of the MAC. For example, in some exemplary embodiments, the MAC controller receives data from a plurality of IMUs positioned within a plurality of different vehicles. In some embodiments, the data inputs to the MAC controller may include image data collected from sensors, such as video devices, imaging devices, and/or cameras. In the exemplary embodiment, motion capture cameras may be used with the MAC as the primary data collection. In other embodiments, the IMU model inputs may include additional and/or alternative inputs. In some embodiments, the inputs may include data collected from sensors, such as radar, LIDAR, proximity sensors, ultrasonic sensors, electromagnetic sensors, Global Positioning System (GPS), torque meters, pressure sensors, accelerometers, beam-break and infrared sensors, and/or gyroscopes.

In the exemplary embodiment, the MAC described herein enables vehicle cup holders to be tested for retention of beverage containers. Moreover, the systems and methods described herein enable the determination of the retention of beverage containers in vehicle beverage container holders using test equipment that replicates the testing performed in a CBU test. More specifically, in at least some embodiments, control and operation of the MAC is driven by a controller that is based on at least one algorithm and based on data received during at least one previously performed complete build up vehicle test. The MAC enables CBU testing to be replicated in a controlled environment and in a manner that is duplicatable and verifiable.

At least one of the technical problems addressed by this system methods may include: (i) improving the reliability and repeatability of data gathered during testing of a vehicle fixture; (ii) improving the cost-effectiveness of testing of a vehicle fixture; (iii) improving the ability to replicate CBU tests in a safe environment that is not weather-dependent; (iv) improving data analysis functionality of vehicle fixture testing; (v) enhancing collection methodologies of vehicle fixture testing; (vi) improving vehicle fixture testing; and/or improving the resolution of the data collected as compared to other known testing methods and systems used with vehicle fixtures.

The methods and systems described herein may be implemented using computer programming or engineering techniques including computer software, firmware, hardware, or any combination or subset thereof, wherein the technical effects may be achieved by performing at least one of the following steps: a) collect a first plurality of sensor information observed/sensed by at least a first sensor during operation of a CBU test vehicle; b) insert an article, such as a beverage container, within a vehicle fixture, such as a beverage container holder, secured to a multi-axis centrifuge that includes a fixturing plate and a magnetic braking system; and c) collect a second plurality of sensor information observed/sensed as the MAC is operated in a manner that replicates the CBU test.

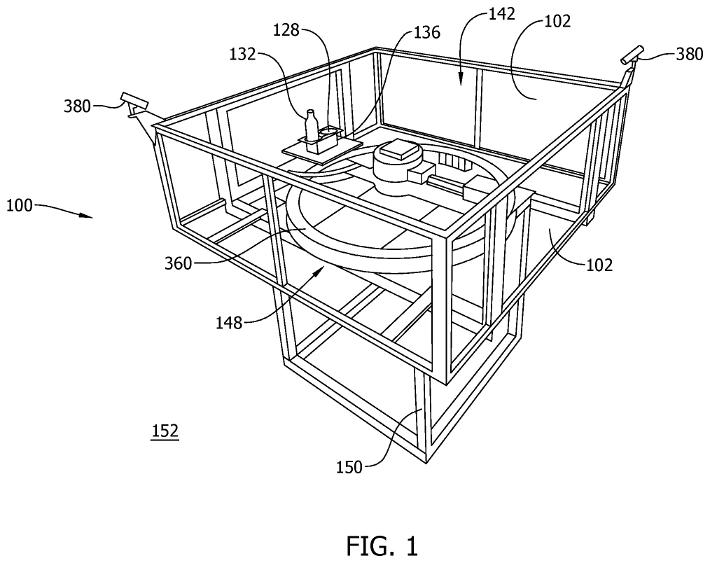

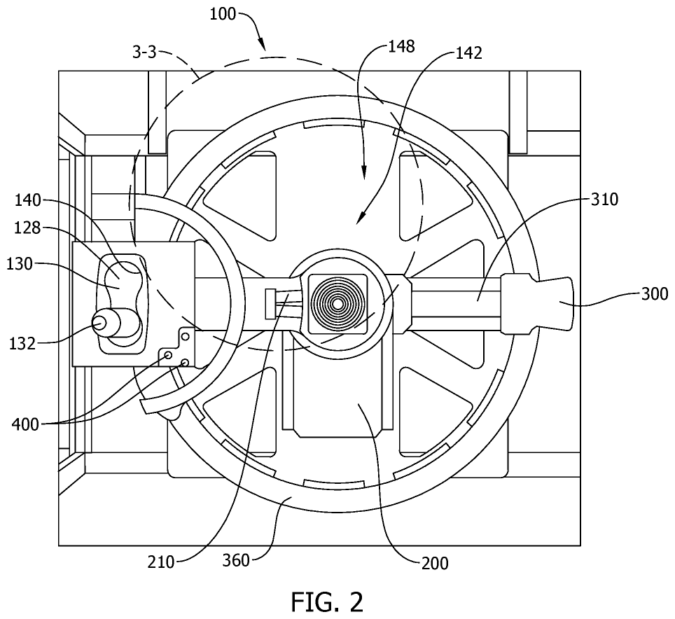

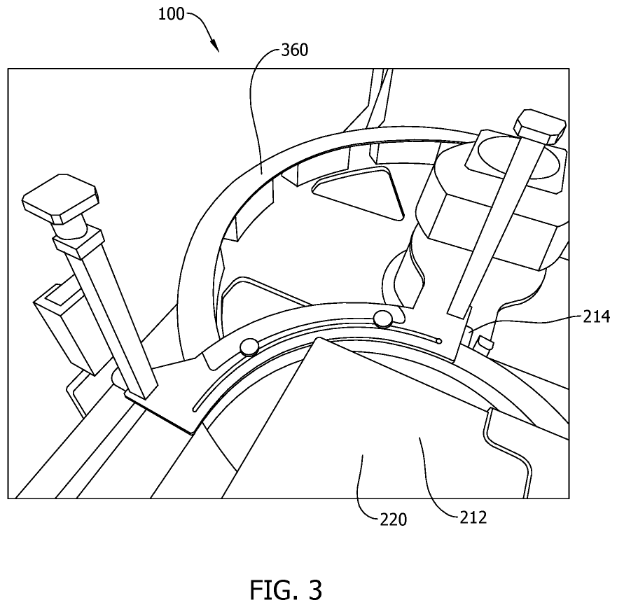

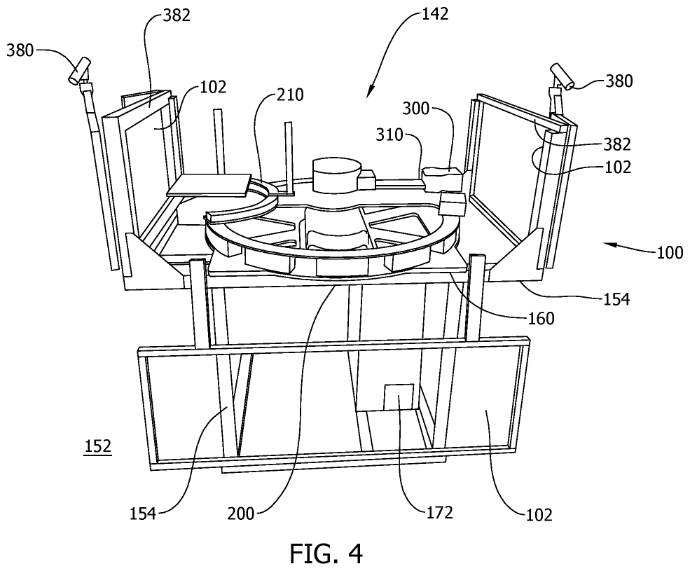

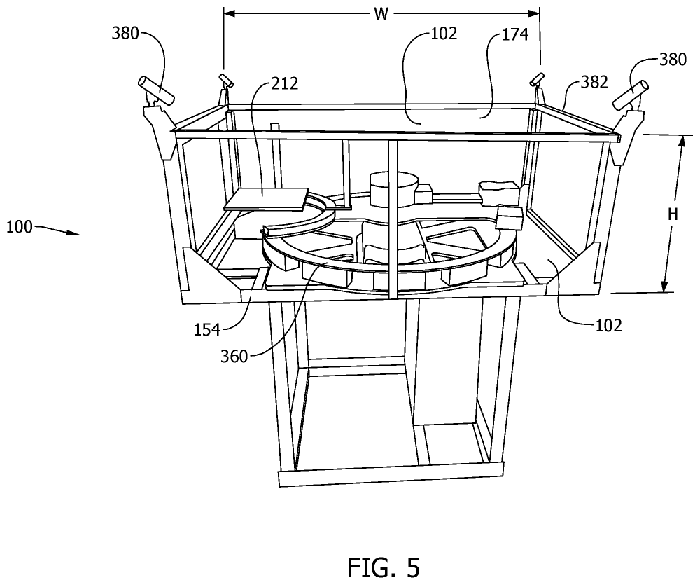

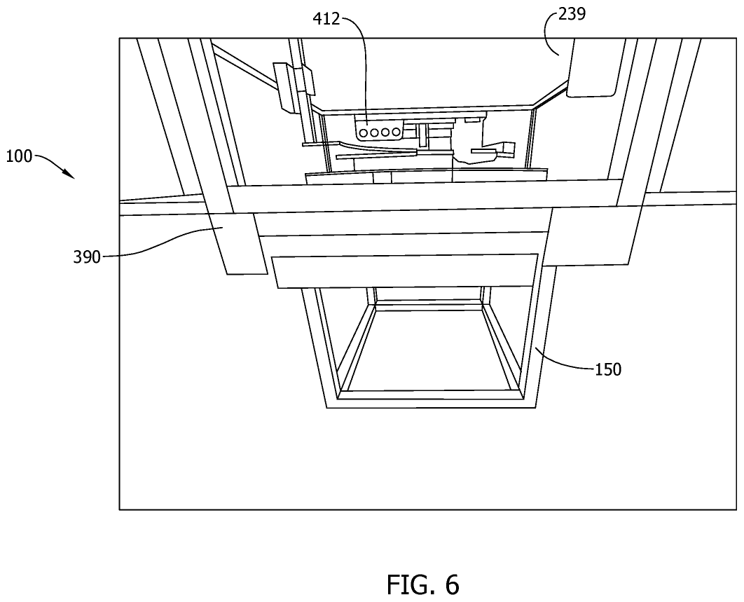

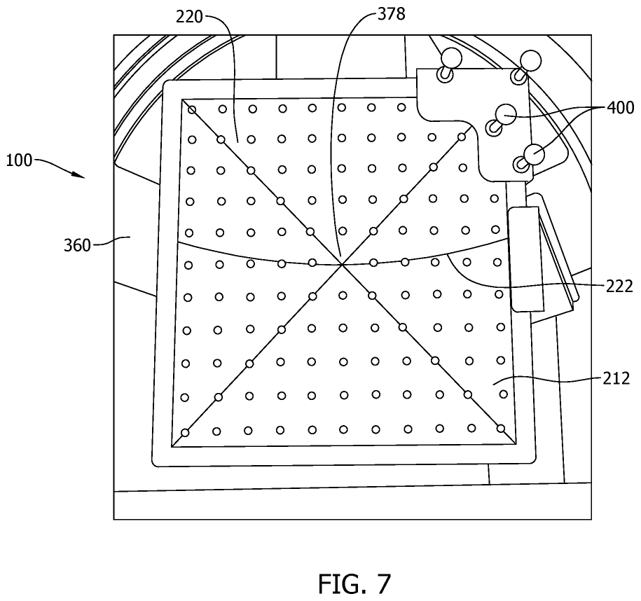

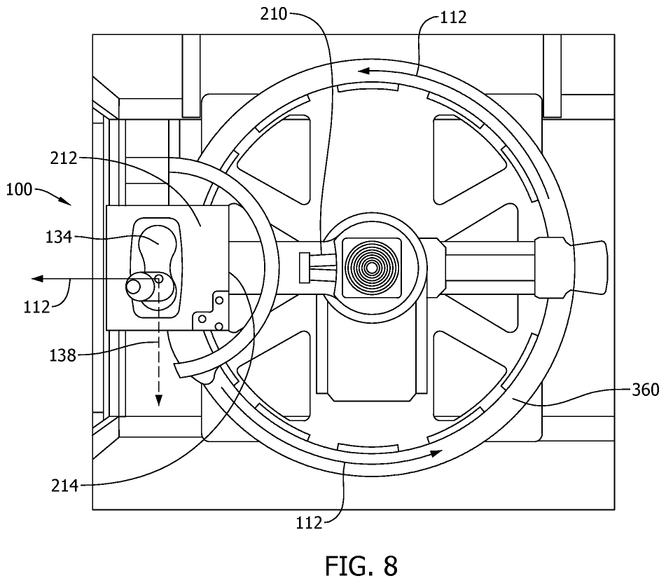

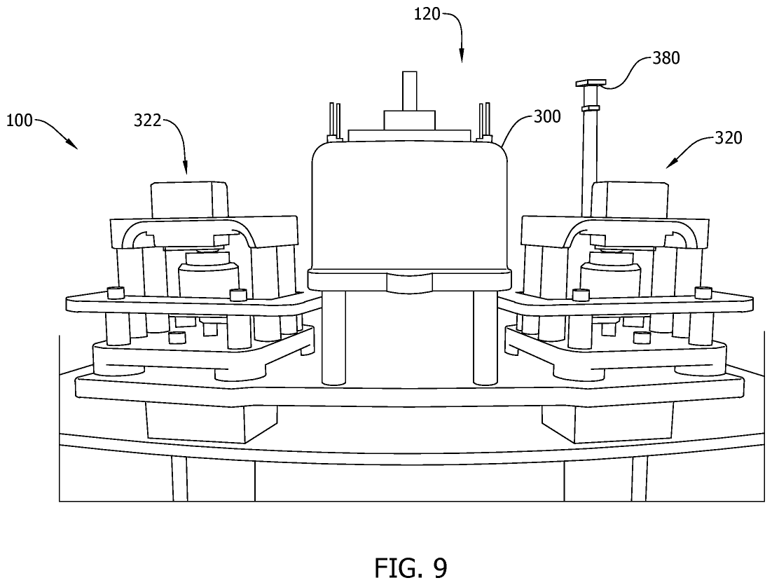

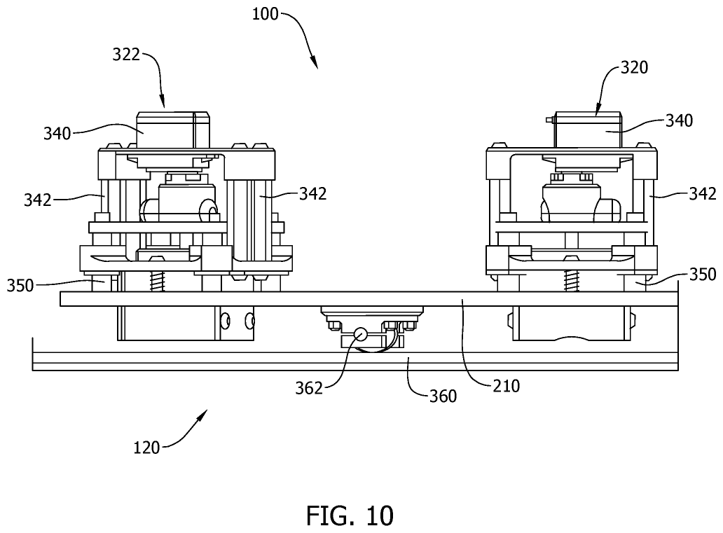

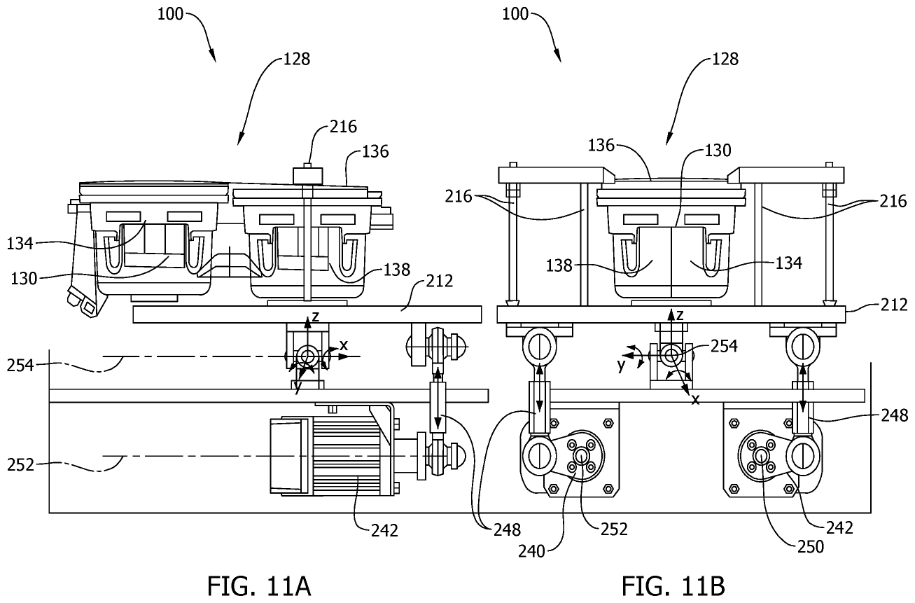

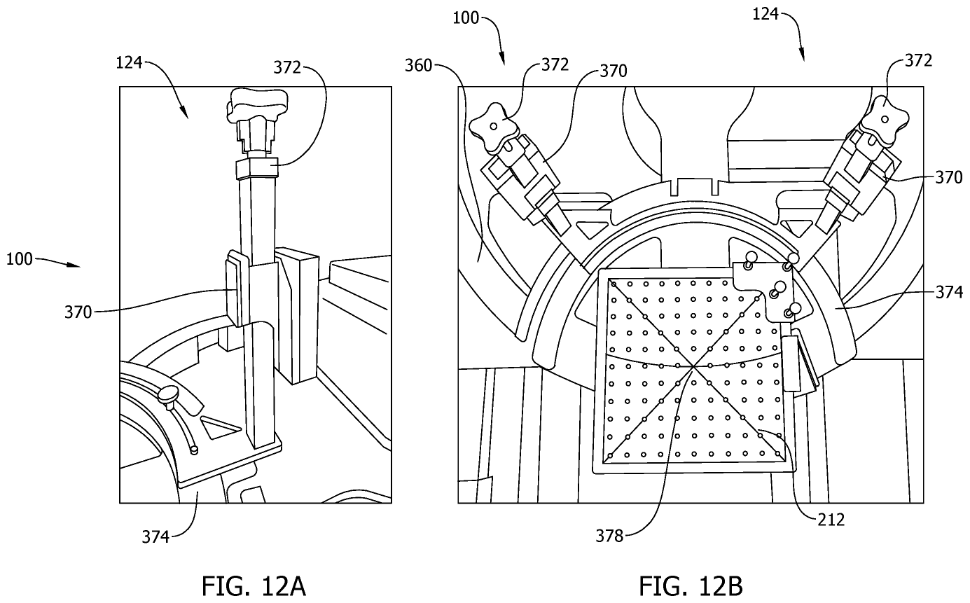

FIG. 1 illustrates a perspective view of an exemplary vehicle fixture testing assembly 100. FIG. 2 is a top plan view of the testing assembly 100, and FIG. 3 is an enlarged view of a portion of the testing assembly 100 taken along area 3-3 shown in FIG. 2. FIG. 4 is right side perspective view of the testing assembly 100 and including a portion of deployable safety shields 102 installed, and FIG. 5 is a right side perspective view of the testing assembly 100 wherein all of the deployable safety shields 102 are installed in position for testing. FIG. 6 is a front perspective view of the testing assembly 100. FIG. 7 is a fixturing plate 212 used with the testing assembly 100. FIG. 8 is a plan view of the testing assembly 100 and includes exemplary forces 112 superimposed on the testing assembly 100. FIG. 9 is an enlarged side view of an exemplary braking system 120 used with the testing assembly 100. FIG. 10 is a schematic side view of the braking system 120. FIGS. 11a and 11b are each schematic side views of a portion of the testing assembly 100. FIG. 12a is a side perspective view of a portion of a camera system 124, and FIG. 12b is a plan view of the testing assembly 100 including the camera system 124.

It is common for vehicles (not shown) to include at least one beverage or cup holder assembly 128 that is sized to receive a beverage container 132 therein, such as a cup, a holder, a can, and/or a bottle, for example. The beverage holder assembly 128 includes a beverage or cup holder 130 that is designed to maintain the beverage container 132 in an upright orientation and stabilized position while the associated vehicle travels. Generally, the cup holder 130 is formed as a housing 134 that is open at the top 136 and that includes a side wall 138 that circumscribes the housing 134 such that at least one opening 140 (often the opening 140 is circular) is defined that is sized to receive a beverage container 132 therein. To facilitate accommodating containers 132 of various shapes and diameters within the same housing 134, and to grip the containers 132 in a stable manner, i.e., without play, the cup holders 130 often include at least one mechanism (not shown) within the cup holder 130 that facilitates the cup holder 130 accepting various sizes and shapes of different containers 132 inserted therein. For example, some known cup holders 130 include a spring-loaded or biased arm that grips the lower portion of a container 132 inserted therewithin. Other known cup holders 130 may include a plurality of resilient, deformable members (not shown) that extend radially inwardly into the opening 140 to essentially deform in close contact against a container 132 inserted into the cup holder 130.

In each embodiment, the cup holder 130 should retain the beverage container 132 inserted within the beverage holder assembly 128 while the associated vehicle is in operation. More specifically, although a beverage container 132 may tip depending on the motion of the vehicle, it should not be ejected from the cup holder 130 and should remain secured within the beverage holder assembly 128 during vehicle operation. During testing, a tip angle of a beverage container 132 within cup holder 130 is measured continuously and is also used as an additional judgement criterion (i.e., compared to pre-defined max threshold tip angle data) for determining whether a cup holder 130 and associated beverage holder assembly 128 successfully passed testing. Specifically, in the exemplary embodiment, tip angle data is captured about every 10 ms and is transmitted as described in more detail below.

Moreover, the beverage cup holder 130 should be sized to enable beverage containers to be easily inserted and/or removed from the cup holder 130. Accordingly in one embodiment, the present invention is directed to test equipment that enables CBU testing to be replicated in a controlled environment that is more cost-effective and verifiable than is possible with CBU tests. In another embodiment, systems and methods are provided that enable accurate and reliable beverage cup retention testing of beverage cup holders.

In the exemplary embodiment, the vehicle fixture testing assembly 100 facilitates testing the retention of beverage containers 132 within vehicle cup holders 130 during vehicle operation. In alternative embodiments, vehicle fixture testing assembly 100 can be used to test any other vehicle fixture and/or small item storage fixture, including, but not limited to only including, eye glass holders, cell-phone holders, seat restraint devices, storage organizers, car-seat carriers, and/or tablet holders. In the exemplary embodiment, the testing assembly 100 uses a multi-axis centrifuge 142 that may be used to replicate CBU testing. More specifically, in the exemplary embodiment, centrifuge 142 is supported within assembly 100 by a plurality of legs 150 that extend from the floor 152 to a work platform 154. In one embodiment, a relative height of each of the legs 150 is adjustable to enable a height of the work platform 154 to be selectively adjusted and/or to facilitate adjusting the levelness, i.e., the relative orientation, of the work platform 154 relative to the floor 152. In other embodiments, assembly 100 may be supported by any number of legs 150 including more or less than four legs 150. For example, in one embodiment, testing assembly 100 is designed for use on a work bench, for example, and in such an embodiment, testing assembly 100 does not include any legs 150. Moreover, in the exemplary embodiment, testing assembly 100 includes retractable casters (not shown) that enable assembly 100 to be easily moved.

In the exemplary embodiment, work platform 154 is supported by a frame 160 that provides structural stability and rigidity to the work platform 154. In other embodiments, testing assembly 100 is in a “benchtop” configuration, wherein the testing assembly 100 is supported by a work table for example, and frame 160 is not used. Safety shields 102 are each coupled to frame 160. More specifically, in the exemplary embodiment, frame 160 is generally rectangular and four shields 102 are coupled to frame 160. In other embodiments, frame 160 may have any other non-rectangular shape that enables testing assembly 100 to function as described herein. Moreover, in other embodiments, testing assembly 100 may include any other number of safety shields 102.

In the exemplary embodiment, shields 102 are generally planar, clear, and each is generally rectangular shaped. Moreover, in the exemplary embodiment, shields 102 are each sized with a width W and a height H that enables shields 102 to fully circumscribe the work platform 154 when the shields 102 are each fully deployed in an operation position for testing, as shown in FIG. 5. More specifically, in the exemplary embodiment, a front shield 170 and a rear shield 172 are each coupled via a hinge to the work platform 154. In alternative embodiments, any and/or all of shields 102 may be fixedly secured in position and are not selectively moveable. Moreover, in the exemplary embodiment, the shields 102 are fabricated from a polycarbonate material. In alternative embodiments, shields 102 may be fabricated from any other material that enables assembly 100 to function as described herein.

The MAC 142 includes a relatively large central arm 210 that is drivingly coupled to a main drive motor 200, and that is coupled to a secondary fixturing plate 212 along a radially outermost edge 214 of an opposite end of the arm 210. In alternative embodiments, any other drive mechanism may be used that enables testing assembly 100 to function as described herein, such as, but not limited to a variable frequency drive (VFD). In the exemplary embodiment, the fixturing plate 212 includes a series of openings 215 (for clarity, openings 215 are only illustrated in FIG. 3, FIG. 7 and FIG. 12b). In the exemplary embodiment, openings 215 are identical and are substantially evenly spaced across fixturing plate 212. In some embodiments, openings 215 are threaded. Each opening 215 is sized to receive fastening hardware 216 therethrough to enable the vehicle fixture being tested to be securely coupled to the fixturing plate 212. Moreover, openings 215 also enable additional sensors to be modularly mounted to the fixturing plate 212 for additional data collection. Plate 212, in the exemplary embodiment, is permanently marked with a Cartesian coordinate grid 220 and with at least one arcuate radius line 222. More specifically, in the exemplary embodiment, the fixturing plate 212 is etched with the grid 220 and each radius line 222. Alternatively, the fixturing plate 212 may be marked with any other identification indicia that enables the fixturing plate 212 to function as described herein. The coordinate grid 220 and radius lines 222, in combination with the openings 215 enable the vehicle cup holder assembly 128 or any other vehicle fixture being tested to be securely coupled to the MAC 142 in a reliable manner and at a location that is easily verifiable, reliable, and duplicatable. Moreover, the fixturing plate 212 enables the cupholder assembly 128 to be securely coupled to the plate 212 in any desirable orientation relative to the fixturing plate 212. As such, the fixturing plate 212 enables a user to selectively control the relative direction of the centrifugal force 112 generated during operation of the MAC 142 and exerted on the cup holder assembly 128 as compared to the position the cupholder assembly 128 would occupy in a vehicle.

In the exemplary embodiment, at least one safety shield 102 includes a door 239 formed therein that may be selectively opened to provide access to the fixturing plate 212 and to a beverage cupholder assembly 128 coupled to the fixturing plate 212, and/or a beverage container 132 positioned within a cup holder 130. In some embodiments, a magnetic safety sensor automatically disengages operation of the main drive motor 200 when the door 239 is opened.

In the exemplary embodiment, movement of the fixturing plate 212 is controlled by a pair of secondary drive motors 240 and 242. More specifically, in the exemplary embodiment, motors 240 and 242 are identical and each is a variable speed motor. In an another embodiment, either motor 240 and/or 242 may include a gear box that enables control of the rotation speed at a user desired speed. Moreover, motors 240 and 242, in the exemplary embodiment, are brushless servo motors in which the rotation speed of motors 240 and 242 are driven by a pulse width modulation (PWM) signal transmitted from a servo controller. In alternative embodiments, any other motors and/or drive mechanisms may be used that enable testing assembly 100 to function as described herein. More specifically, in the exemplary embodiment, motors 240 and 242 are suspended below the fixturing plate 212 and each is coupled to the fixturing plate 212 by rod ends 248, such that the fixturing plate 212 is rotatable about two localized axes 250 and 252, as well as independently rotatable about the main axis 254 of the central arm 210. Rotation of the fixturing plate 212 facilitates simulating the forces that the cup holder assembly 128 and a beverage container 132 contained therein may be exposed to during movement, including acceleration, turning, and/or bumps from rough or un-even terrain. The additional fixturing plate axes 250 and 252 facilitate the inclusion of dynamic simulations of conditions such as, but not limited to, bumpy roads, speed bumps, pot holes, and/or rapid start/stop conditions, including emergency stops. Moreover, the MAC 142 uses the generated centrifugal force present in its rotating system, to simulate the same dynamic forces a beverage cup holder assembly 128, a cup holder 130, and/or a beverage container 132 may experience in a moving vehicle.

In the exemplary embodiment, motors 240 and 242 are each driven based on data collected from previous CBU vehicle testing over various road conditions. More specifically, in the exemplary embodiment, an inertial measurement unit (IMU) provides relevant force data to a MAC controller 300 to enable dynamic control of the MAC 142. Specifically, operation of the multi-axis centrifuge 142 is based on information and data gathered from at least one CBU test vehicle while that vehicle was driven through a controlled environment, i.e., a test road course/track. The MAC controller 300 receives data from a plurality of sensors and cameras coupled about the CBU test vehicle. In the exemplary embodiment, the CBU test vehicle is driven through a test course that includes a plurality of different road conditions including, but not limited to, areas including left and right turns of various degrees, a range of braking from normal braking activities to sudden braking events, various acceleration spurts, U-turns, and areas including rough terrain and/or speed bumps.

Data from any sensors and the IMU in the CBU test vehicle is processed through an algorithm in the MAC controller 300 to facilitate control of operation of the MAC 142 based on inputs received from the IMU. As such, testing of the vehicle fixture can be performed in a repeatable and reliable manner without the concerns and issues raised by gathering data from a CBU test vehicle in variable weather conditions, for example.

In one embodiment, the MAC controller 300 utilizes at least two process models that may be dynamically updated by a user to determine a course of operation for the MAC 142. In some embodiments, the MAC controller 300 executes an algorithm to determine the operation of the MAC 142. For example, in some exemplary embodiments, the MAC controller 300 receives data from a plurality of different CBU test vehicles. In some embodiments, the data inputs to the MAC controller 300 may include image data collected from sensors, such as video devices, imaging devices, and/or cameras. In other embodiments, the IMU model inputs may include additional and/or alternative inputs. In some embodiments, the inputs may include data collected from sensors, such as radar, LIDAR, proximity sensors, ultrasonic sensors, electromagnetic sensors, Global Positioning System (GPS), torque meters, pressure sensors, accelerometers, beam-break and infrared sensors, and/or gyroscopes.

In the exemplary embodiment, the MAC controller 300 is located on the testing assembly 100 at the center of the central arm 210. More specifically, on the outer edge 310 of the central arm 210, opposite the fixturing plate 212, a pair of magnetic braking assemblies 320 and 322 are coupled. In the exemplary embodiment, braking assemblies 320 and 322 are identical, and each includes an electric actuator 340, vertical guide rails 342, and a magnetic clamp 350. More specifically, in the exemplary embodiment, the MAC main arm assembly 210 rides on a steel rail 360 suspended by three roller assemblies 362. In the exemplary embodiment, rail 360 extends circumferentially within testing assembly 100. Moreover, in the exemplary embodiment, roller assemblies 362 are identical. In alternative embodiments, the MAC main arm assembly 210 may be supported by more or less than three roller assemblies 362 and/or testing assembly 100 may include a plurality of different rail assemblies 362. In the exemplary embodiment, electric actuators 340 are electric servo actuators. Alternatively, any other actuator that enables testing assembly 100 to function as described herein may be used.

When the electric actuator 340 is signaled, by a user and/or by MAC controller 300, based on at least one algorithm and/or based on data received from at least one previously performed CBU vehicle test, braking assemblies 320 and 322 cause the actuator to rapidly engage each magnetic clamp 350 which have a sufficiently strong enough field when engaged to stop rotation of the main arm assembly 210. More specifically, such dynamic control, by the MAC controller 300, and the action of the braking assemblies 320 and 322 facilitates replicating the braking forces generated in the CBU vehicle testing during acceleration and braking of the vehicle. Moreover, the combination of the dynamic control and the braking assemblies 320 and 322 provide a safety feature to the testing assembly that enables the rotation to be rapidly stopped if necessary, such as if a beverage container 132 was about to become ejected and/or had been ejected from a cup holder assembly 128.

In the exemplary embodiment, testing assembly 100 also includes a plurality of sensors 370 that capture information about testing being performed on testing assembly 100. More specifically, in the exemplary embodiment, sensors 370 are cameras that capture image data during testing. In some embodiments, the sensors 370 include cameras, proximity detectors, and/or other sensors 370 that can provide information about the surroundings of the beverage cup holder assembly 128 being tested, such as, but not limited to, g-forces induced on the cup holder assembly 128, the cup holder 130, and/or the beverage container 132, the size and type of beverage container 132 in the assembly 128 being tested, and/or the relevant vehicle dynamics and forces induced to the holder assembly 128 during testing.

In one embodiment, sensors 370 are part of an interactive visualization system that includes multi-cameras 370 that transmit images through a neural network, wherein the image data transmitted corresponds to movements of the beverage container 132 in real time as the beverage cup holder assembly 128 is being tested. The cameras are integrated with a display that provides a high-definition display to a user. In one embodiment, the cameras 370 may be spaced about testing assembly 100 in in any orientation that enables the testing assembly 100 to function as described herein. Initially, when an image is detected, the cameras transmit the image data to a processing neural network that is coupled to a memory.

In the exemplary embodiment, testing assembly 100 includes at least two cameras 370 that collect image data of the beverage cup holder assembly 128, the cup holder 130, and the beverage container 132 as the arm 210 rotates, i.e., moves about the guide rail 360 during testing. More specifically, in the exemplary embodiment, a pair of cameras 370 are coupled to selectively adjustable lead screws 372 and extend outward from the center of fixturing plate 212. Lead screws 372 enable an orientation and a relative height of cameras 370 to be variably selected to any location along an accurate track 374 that extends partially about fixturing plate 212. As such, in the exemplary embodiment, cameras 370 are oriented 90° from each other along the track 374. Moreover, for standardization, cameras 370 in the exemplary embodiment, always face towards the center point 378 of fixturing plate 212, but can be rotated about the center point 378 on track 374 to avoid potential and/or beverage cup ejection paths during testing. In the exemplary embodiment, cameras 370 may be any device enabled to capture images, such as, and without limitation, a camera capable of capturing a plurality of image frames, a camera capable of capturing sequential image frames, a camera capable of capturing a video stream, and/or the like. In the exemplary embodiment, cameras 370 are identical. Moreover, in alterative embodiments, testing assembly 100 includes more or less than two cameras 370. Cameras 370, may include, but are not limited to only including, a neuromorphic camera, a digital camera, an infrared camera, a drone camera, a mirrorless camera, and or any other camera 370 that enables testing assembly 100 to function as described herein. Alternatively, the testing assembly 100 may include any other camera locations that enables testing assembly 100 to function as described herein. For example, in some embodiments, assembly 100 may also include a “point-of-view” camera coupled to the beverage container 132 and or the beverage cup holder assembly 128 being tested. The cameras 370 may collect image data, continuously and/or periodically at set intervals and/or on demand, and then transmit the collected image data to the testing system 100 and/or MAC controller 300. The image data may be transmitted periodically, e.g., every second or every minute, at pre-determined time intervals, and/or in any suitable time increment, that enables the testing assembly 100 to function as described herein.

In the exemplary embodiment, the cameras 370 are positioned to capture data from the rotating beverage cup holder assembly 128 being tested. More specifically, in the exemplary embodiment, the cameras 370 may be substantially vertically-aligned with, and/or slightly above, the beverage cup holder assembly 128 being tested. Testing assembly 100 also includes a plurality of dedicated motion-capture cameras 380, also known as trackside cameras, that are coupled to shields 102 such that cameras 380 are vertically above the beverage cup assembly 128 being tested and these cameras 380 may be oriented at other alignments as compared to cameras 370. In the exemplary embodiment, a position of the motion capture cameras 380 may be selectively varied by a user along an edge 382 of shields 102. In the exemplary embodiment, the motion capture cameras 380 are variably positioned at sufficient spacing to ensure that any motion of the beverage cup holder assembly 128, the cup holder 130, and or the beverage container 132 relative to the assembly 128 is always in view of at least one of the motion capture cameras 380. The combination of cameras 370 and 380 enables any motion and movement of beverage cup holder assembly 128, the cup holder 130, and/or beverage container 132 to be identified and captured. Moreover, the combination of cameras 370 and 380 also enables continuous monitoring of the relative position of fixturing plate 212 and the central arm 210. In some embodiments, the testing assembly 100 includes at least four trackside cameras 380. In alternative embodiments, testing assembly 100 may include at least one overhead camera (not shown) suspended above assembly 100. In the exemplary embodiment, testing assembly 100 includes a motion camera interface 390 that enables additional cameras 380 to be easily mounted and included in test data collection.

In the exemplary embodiment, testing assembly 100 includes a plurality of infrared lights (not shown) that are spaced about the MAC controller 300. The infrared lights, when rotated, provide an indicator to MAC controller 300 that testing is underway and to begin capturing data from assembly 100. In the exemplary embodiment, testing assembly 100 includes a processor that stores data gathered during testing, and that enables a user to make dynamic changes to testing parameters. Moreover, an additional sensor panel 412 enables additional sensors to be added to testing assembly 100 to enable additional data to be gathered relevant to fixturing plate 212. Furthermore, an operations control panel 414 enables a user to selectively control power to testing assembly 100 and enables a user to plug into the MAC to enable the user interface and the MAC controller 300 to communicate with each other.

A processor coupled to the MAC controller 300 enables computer-executable instructions for implementing aspects of the disclosure. In some embodiments, the processor is transformed into a special purpose microprocessor by executing computer-executable instructions or by otherwise being programmed. For example, the processor may be programmed with instructions. The processor may also be operatively coupled to a storage device. The storage device may be any computer-operated hardware suitable for storing and/or retrieving data, such as, but not limited to, data associated with the database. In some embodiments, the storage device is integrated in a server computer device. For example, the server computer device may include one or more hard disk drives as storage device. In other embodiments, the storage device is external to the testing assembly 100.

During use, initially a vehicle fixture is coupled to a fixturing plate that is coupled securely within a multi-axis centrifuge. More specifically, as described herein, the vehicle fixture is coupled to the fixturing plate using a coupling system that facilitates positioning the vehicle fixture in any orientation and position relative to the centrifuge. Data gathered from testing of at least one vehicle fixture in at least one vehicle is input from the IMU into the MAC controller, wherein the data input is a measure of forces induced to the vehicle fixture during testing in the at least one vehicle. The MAC controller dynamically controls operation of the centrifuge. Furthermore, during testing, the MAC controller gathers additional data from sensors on the testing assembly during testing of the vehicle fixture. The data gathered during operation of the centrifuge enables the effectiveness of the vehicle fixture to be evaluated.

The computer-implemented methods and processes described herein may include additional, fewer, or alternate actions, including those discussed elsewhere herein. The present systems and methods may be implemented using one or more local or remote processors, transceivers, and/or sensors (such as processors, transceivers, and/or sensors mounted on vehicles, stations, nodes, or mobile devices, or associated with smart infrastructures and/or remote servers), and/or through implementation of computer-executable instructions stored on non-transitory computer-readable media or medium. Unless described herein to the contrary, the various steps of the several processes may be performed in a different order, or simultaneously in some instances.

Additionally, the computer systems discussed herein may include additional, fewer, or alternative elements and respective functionalities, including those discussed elsewhere herein, which themselves may include or be implemented according to computer-executable instructions stored on non-transitory computer-readable media or medium.

In the exemplary embodiment, a processing element may be instructed to execute one or more of the processes and subprocesses described above by providing the processing element with computer-executable instructions to perform such steps/sub-steps, and store collected data (e.g., beverage cup holder profiles, etc.) in a memory or storage associated therewith. This stored information may be used by the respective processing elements to make the determinations necessary to perform other relevant processing steps, as described above.

The aspects described herein may be implemented as part of one or more computer components, such as a client device, system, and/or components thereof, for example. Furthermore, one or more of the aspects described herein may be implemented as part of a computer network architecture and/or a cognitive computing architecture that facilitates communications between various other devices and/or components. Thus, the aspects described herein address and solve issues of a technical nature that are necessarily rooted in computer technology.

The exemplary systems and methods described and illustrated herein therefore significantly increase the reliability, replicating, and verifying of testing beverage cup holder assemblies and/or other vehicle fixtures by reducing the costs, uncertainty, and non-duplicatable data commonly associated with known cup holder assembly testing. The present systems and methods are further advantageous over conventional testing techniques and the embodiments herein are not confined to a single type of vehicle, cup holder assembly, and/or vehicle fixture, but may instead allow for versatile operation within multiple different types of vehicles, multiple types of beverage cup holder assemblies, and/or multiple types of vehicle fixtures. Accordingly, these novel techniques are of particular value to vehicle manufacturers who desire to have these methods and systems available for the users of their vehicles.

Exemplary embodiments of systems and methods for reliably testing vehicle fixtures are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computer devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A multi-axis centrifuge comprising:
a rotating arm having a main axis and comprising a first end, and an opposite second end;
a motor configured to drive said arm;
a fixturing plate coupled to an outermost edge of said arm first end such that said fixturing plate is rotatable about the arm main axis,
at least one braking assembly coupled to said arm second end; and
a controller configured to dynamically control operation of said multi-axis centrifuge.

2. The centrifuge of claim 1 further comprising a rail system supporting said rotating arm, said rail system supported by a plurality of roller assemblies.

3. The centrifuge of claim 1 wherein said controller facilitates inducing the forces that a fixture assembly in a moving vehicle to a fixture assembly being tested in the centrifuge.

4. The centrifuge of claim 3 wherein said fixturing plate comprises a grid and at least one radius line that enable the fixture assembly being tested to be coupled to the centrifuge in any orientation.

5. The centrifuge of claim 3 wherein said fixturing plate facilitates controlling the relative direction of the centrifugal force directed towards the fixture assembly being tested during centrifuge operation.

6. The centrifuge of claim 3 wherein said at least one braking assembly comprises an actuator extending between at least one guide rail and a clamp, during operation, said at least one braking assembly configured to selectively stop rotation of the centrifuge arm.

7. The centrifuge of claim 4 wherein said at least one braking assembly comprises at least two braking assemblies that selectively induce the braking forces of a vehicle to the fixture assembly being tested.

8. The centrifuge of claim 4 further comprising an inertial measurement unit that transmits force data to said controller, said controller dynamically controls movement of said centrifuge using data received from said inertial movement unit.

9. A testing assembly for use in testing a vehicle fixture, said testing assembly comprising:
a multi-axis centrifuge comprising a central arm, said arm coupled to a drive motor configured to rotate said central arm circumferentially along a rail guide;
a fixturing plate secured to a first end of said central arm, said fixturing plate comprising a plurality of openings sized to receive a fastener assembly therethrough for securing the vehicle fixture in a desired position and orientation to said fixturing plate;
a braking assembly comprising at least one electric actuator coupled to said central arm for selectively stopping rotation of said central arm; and
a controller configured to provide dynamic control of the multi-axis centrifuge using data gathered from testing of at least one vehicle, said controller receives additional data from said testing assembly during testing of a vehicle fixture.

10. The testing assembly of claim 9 further comprising an inertial measurement unit that transmits force data to said controller, said controller dynamically controls movement of said centrifuge.

11. The testing assembly of claim 10 further comprising at least one camera coupled radially outwardly from said fixturing plate, said at least one camera transmits data to said controller.

12. The testing assembly of claim 10 wherein said controller enables a data capture rate of said at least one camera to be variably selected.

13. The testing assembly of claim 10 further comprising at least two secondary motors coupled to said fixturing plate, said secondary motors control rotation of said fixturing plate relative to said central arm.

14. The testing assembly of claim 10 wherein said fixturing plate further comprises a grid and at least one radius line that in combination facilitate accurate and repeatable coupling of to the fixturing plate in any orientation.

15. The testing assembly of claim 10 wherein said fixturing plate is configured to facilitate controlling the relative direction of the centrifugal force directed towards the fixture assembly being tested during centrifuge operation.

16. The testing assembly of claim 10 wherein said at least one braking assembly comprises at least two braking assemblies that selectively induce the braking forces of a vehicle to the fixture assembly being tested during centrifuge operation.

17. The testing assembly of claim 10 further comprising a plurality of infrared lights that when energized facilitate controlling data collection during testing of the fixture assembly.

18. A method of testing a vehicle fixture comprising:
coupling a vehicle fixture to a fixturing plate coupled within a multi-axis centrifuge using a coupling system that facilitates positioning the vehicle fixture in any orientation and position relative to the centrifuge, wherein the fixturing plate is coupled to a first end of a central arm of the centrifuge;
inputting data gathered from testing of at least one vehicle fixture in at least one vehicle, wherein the data is a measure of forces induced to the vehicle fixture during testing in the at least one vehicle;
dynamically controlling operation of the centrifuge using a controller;
gathering, by the controller, data measured during testing of the vehicle fixture while coupled to the centrifuge; and
determining effectiveness of the vehicle fixture based on the data gathered during operation of the centrifuge.

19. The method of claim 18 wherein coupling a vehicle fixture to a fixturing plate coupled within a multi-axis centrifuge further comprises coupling the vehicle fixture to the fixturing plate by inserting a coupling mechanism through at least one hole defined on the fixturing plate.

20. The method of claim 19 wherein gathering, by the controller, data measured during testing of the vehicle fixture further comprises selecting by the controller, a data collection rate of data to be gathered by at least one camera.
